(19) United States
(12) Patent Application Publication
(10) Pub. No.: US 2025/0017425 A1
(43) Pub. Date: Jan. 16, 2025

(54) SYSTEMS FOR WATER DAMAGE PREVENTION IN STAND MIXER APPLIANCES

(71) Applicant: Haier US Appliance Solutions, Inc., Wilmington, DE (US)

(72) Inventors: Danister Abeygunawardana, Jeffersonville, IN (US); Tomas Garces, Louisville, KY (US)

(21) Appl. No.: 18/352,001

(22) Filed: Jul. 13, 2023

(51) Int. Cl. A47J 43/07; A47J 43/044

(52) U.S. Cl. CPC A47J 43/0705; A47J 43/044; A47J 2043/04454

(57) ABSTRACT

A stand mixer includes a base, a support column attached to the base, extending upwardly from the base, a column rail mounted to the support column, and a head attached to an upper end of the support column, extending from the support column above the base. The stand mixer also includes a bowl lift framework extending outwardly from the support column. The bowl lift framework includes a bar linkage configured for moving relative to the head when the bar linkage pivots relative to the support column. The stand mixer further includes a liquid reservoir disposed around the bar linkage inside of the support column. The liquid reservoir includes a bottom wall positioned above an interior of the base of the stand mixer along the vertical direction. The liquid reservoir is configured to prevent liquid from entering the interior of the base.

### FIELD OF THE INVENTION

The present subject matter relates generally to systems for preventing water damage inside of stand mixer appliances.

### BACKGROUND OF THE INVENTION

Stand mixers are generally used for performing automated mixing, churning, or kneading involved in food preparation. Typically, stand mixers include a motor configured to provide torque to one or more driveshafts. Users may connect various utensils to the one or more driveshafts, including whisks, spatulas, or the like. When using the stand mixer, the contents of the bowl can become heavy and difficult to move or manage. When this occurs, it is beneficial to use a specialized mixer. One type of specialized mixer, for example, is a tilt-head mixer. The tilt-head mixer allows the user to tilt the head of the mixer to provide access to the opening of the bowl. Tilt-head mixers may be troublesome as the head of the mixer is typically heavy.

Another type of mixer is the bowl-lift mixer. Bowl-lift mixers include a bowl that can be lifted vertically by a lift system. Arms extending from the mixer support the bowl, and a lever or crank may be rotated to translate the mixing bowl up or down vertically. Using a bowl-lift mixer reduces the difficulty of moving the mixing bowl vertically relative to tilt-head mixers. Bowl-lift mixers, however, may be susceptible to liquid intruding into the mixer while mixing at high speeds.

Accordingly, bowl-lift stand mixers that prevent or minimize liquid intrusion into to the mixer during operation of the mixer would be advantageous.

### BRIEF DESCRIPTION OF THE INVENTION

Aspects and advantages of the invention will be set forth in part in the following description, or may be apparent from the description, or may be learned through practice of the invention.

In one example embodiment, a stand mixer defines a vertical direction, a lateral direction, and a transverse direction. The vertical direction, the lateral direction, and the transverse direction are mutually perpendicular. The stand mixer includes a base, a support column attached to the base, extending upwardly from the base, a column rail mounted to the support column, and a head attached to an upper end of the support column, extending from the support column above the base. The stand mixer also includes a bowl lift framework extending outwardly from the support column. The bowl lift framework is coupled to the column rail. The bowl lift framework includes a bar linkage configured for moving relative to the head when the bar linkage pivots relative to the support column. The stand mixer further includes a liquid reservoir disposed around the bar linkage inside of the support column. The liquid reservoir includes a bottom wall positioned above an interior of the base of the stand mixer along the vertical direction. The liquid reservoir is configured to prevent liquid from entering the interior of the base.

In another example embodiment, a stand mixer includes a base, a support column attached to the base, extending upwardly from the base, and a head attached to an upper end of the support column, extending from the support column above the base. The stand mixer also includes a bowl lift framework extending outwardly from the support column. The bowl lift framework includes a bar linkage configured for moving relative to the head when the bar linkage pivots relative to the support column. The stand mixer further includes a liquid reservoir disposed around the bar linkage inside of the support column.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures.

FIG. 1 provides a perspective view of an example embodiment of a stand mixer of the present disclosure.

FIG. 2 provides a side view of a bowl lift framework of the example stand mixer of FIG. 1.

FIG. 3 provides a side view of the example stand mixer of FIG. 1 in a raised position.

FIG. 4 provides a side view of the example stand mixer of FIG. 1 in a lowered position.

FIG. 5 provides a rear perspective view of an example embodiment of a bowl lift mechanism according to aspects of the present disclosure.

FIG. 6 provides a top perspective view of an example embodiment of a stand mixer with the bowl lift framework of FIG. 5.

FIG. 7 provides a side view of the example embodiment of the stand mixer of FIG. 6.

FIG. 8 provides a side perspective view of the example embodiment of the stand mixer of FIG. 6.

FIG. 9 provides a schematic view of another example embodiment of a liquid reservoir in a stand mixer according to aspects of the present disclosure.

FIG. 10 provides a schematic view of an alternative example embodiment of a liquid reservoir in a stand mixer according to aspects of the present disclosure.

Repeat use of reference characters in the present specification and drawings is intended to represent the same or analogous features or elements of the present invention.

### DETAILED DESCRIPTION OF THE INVENTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope of the invention. For instance, features illustrated or described as part of one embodiment can be used with another embodiment to yield a still further embodiment. Thus, it is intended that the present invention covers such modifications and variations as come within the scope of the appended claims and their equivalents.

As used herein, the terms “includes” and “including” are intended to be inclusive in a manner similar to the term “comprising.” Similarly, the term “or” is generally intended to be inclusive (i.e., “A or B” is intended to mean “A or B or both”). Approximating language, as used herein throughout the specification and claims, is applied to modify any quantitative representation that could permissibly vary without resulting in a change in the basic function to which it is related. Accordingly, a value modified by a term or terms, such as “about,” “approximately,” and “substantially,” are not to be limited to the precise value specified. In at least some instances, the approximating language may correspond to the precision of an instrument for measuring the value. For example, the approximating language may refer to being within a ten percent (10%) margin.

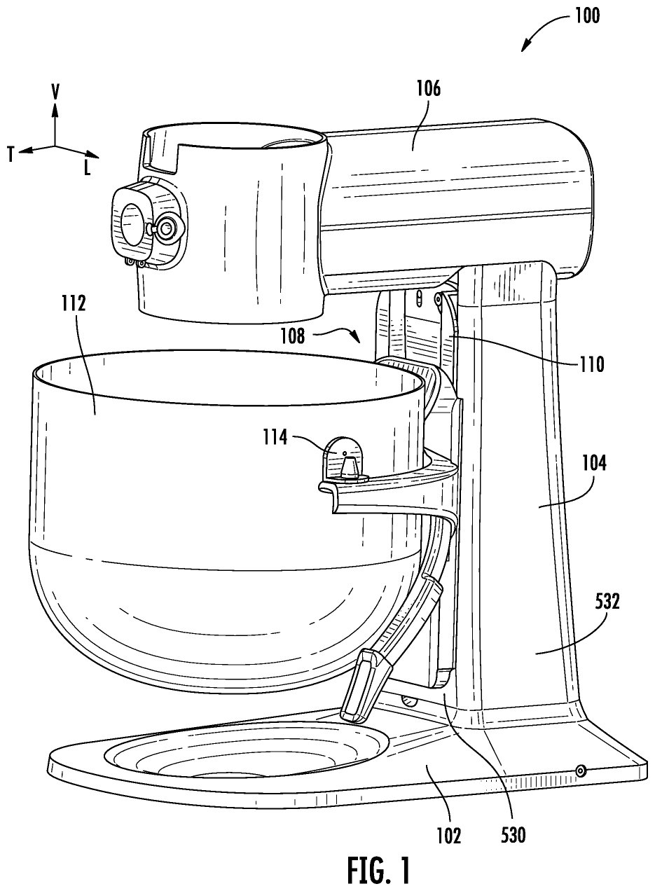

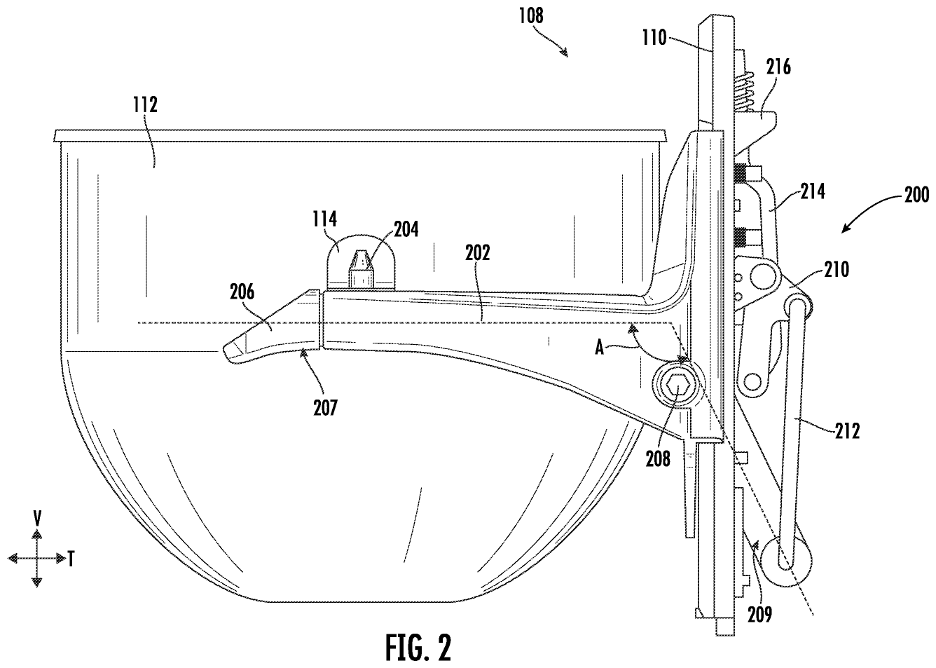

FIG. 1 provides a perspective view of a stand mixer 100 according to an example embodiment of the present subject matter. It will be understood that stand mixer 100 is provided by way of example only and that the present subject matter may be used in or with any suitable stand mixer in alternative example embodiments. Moreover, with reference to each of FIGS. 1 and 2, stand mixer 100 may define a vertical direction V, a lateral direction L, and a transverse direction T, which are mutually perpendicular and form an orthogonal direction system. It should be understood that these directions are presented for example purposes only, and that relative positions and locations of certain aspects of stand mixer 100 may vary according to specific embodiments, spatial placement, or the like.

Stand mixer 100 may include a base 102 and a support column 104. Column 104 may support a mixer head 106, which is positioned atop column 104. Head 106 may house a motor, a gearbox, and/or a drivetrain apparatus (not shown) of stand mixer 100. For example, as shown in FIG. 1, head 106 may be mounted to column 104, which is mounted to base 102. Thus, column 104 may extend between and connect base 102 and head 106, e.g., along the vertical direction V. Head 106 may extend outwardly above the base 102, e.g., in the transverse direction T. Column 104 may also include a bowl lift framework 108. Bowl lift framework 108 may slidably mount to a column rail 110, which is mounted to column 104. Additionally, components of bowl lift framework 108 may extend outwardly above the base 102, e.g., in the transverse direction T, and may hold bowl 112 above base 102, e.g., along the vertical direction V. Bowl 112 may be removably mounted on bowl lift framework 108 via flanges 114. Flanges 114 may be on opposite sides of the bowl 112 with respect to the circumference of the bowl. Bowl lift framework 108 will be described in further detail herein.

Example operation of stand mixer 100 is described below. In the operation of stand mixer 100, a user may load food items into bowl 112. The food items may be ingredients, such as flour, water, milk, etc. These items are provided for example purposes only and one skilled in the art would appreciate that there are many more types of food items that may be placed in bowl 112 of stand mixer 100. After loading the food items into bowl 112, a user may turn on a motor to begin the process of mixing, kneading, beating, etc. The motor rotates an attachment attached to stand mixer 100 to complete each of these processes. The processes may be conducted with a respective attachment, such as a mixer blade for mixing, a dough hook for kneading, and a balloon whisk for beating.

As shown in a side view in FIG. 2, bowl lift framework 108 may include a bowl carrier 202, e.g., with a mounting spike 204. Bowl 112 may be removably mounted on bowl lift framework 108 via flanges 114. Flanges 114 may be on opposite sides of the bowl 112 with respect to the circumference of the bowl. Bowl carrier 202 of bowl lift framework 108 may hold bowl 112 via mounting spike 204 engaging with flanges 114. For instance, each mounting spike 204 on bowl carrier 202 may be received within a respective flange 114 on bowl 112. Lift arm 206 may rotatably couple to bowl carrier 202 via a hinge pin 208. Hinge pin 208 may be a fixed rotational point with respect to bowl carrier 202, e.g., hinge pin 208 may not translate or move apart from bowl carrier 202.

There may be at least two lift arms 206, and bowl 112 may be disposed between lift arms 206, e.g., along the lateral direction L. Each lift arm 206 may be positioned on a respective side of bowl 112, such that both a left-handed user and a right-handed user may comfortably operate lift arms 206. When rotating lift arm 206, bowl carrier 202 may be translated in the vertical direction V by a bar linkage 200 that includes a linkage 210. Specifically, when rotating lift arm 206 about hinge pin 208, a first tension bar 212 of bar linkage 200 pushes and rotates linkage 210 about the lateral L axis. In response to the rotation of linkage 210, a second tension bar 214 of bar linkage 200 may be rotated through a column rail tab 216.

Lift arm 206 may have one end 207 cantilevered from support column 104. Such distal end 207 may correspond to a handle for a user to grasp, push, or pull. The other end 209, e.g., an angled portion, of lift arm 206 may be disposed within support column 104 and may be coupled to first tension bar 212. At the hinge point, hinge pin 208 of lift arm 206, both ends 207. 209 of lift arm 206 may linearly extend outward. The hinge point may be disposed within support column 104. The linear portions of lift arms 206 may be angled between the cantilevered end 207 and the opposite end 209 within support column 104. The angle A formed by the linear portions of lift arm 206 between the cantilevered end 207 and the other end 209, e.g., in a plane perpendicular to the lateral direction L, may be no less than one-hundred degrees (100°) and no more than one-hundred and seventy degrees (170°) in certain example embodiments.

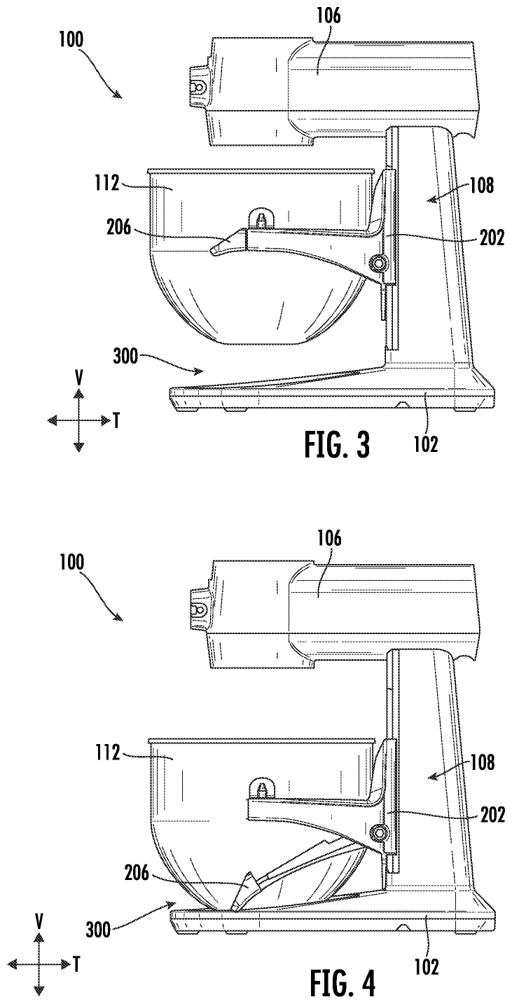

Referring now to FIGS. 3 and 4, stand mixer 100 may adjust between two positions using bowl lift framework 108. The first position, shown in FIG. 3, includes lift arm 206 parallel to the transverse direction T such that bowl carrier 202 may be vertically elevated above base 102 on column rail 110. In particular, the first or upper position may be elevated proximate head 106 for the mixing of ingredients of bowl 112. The second position, shown in FIG. 4, includes lift arm 206 angled away relative to the transverse direction T such that bowl carrier 202 may be proximate base 102. Lift arm 206 may be disengaged by angling lift arm 206 downward toward base 102. In particular, the second or lower position may be closer to base 102 than the first position. Bowl 112 may be in the second position so that there is more space between bowl 112 and head 106 relative to the first position such that ingredients may be added to bowl 112. For example, in the first position, gap 300 of FIG. 3 may be up to five centimeters (5 cm) between base 102 and bowl 112, whereas in the second position shown in FIG. 4, gap 300 may be less than one centimeter (1 cm).

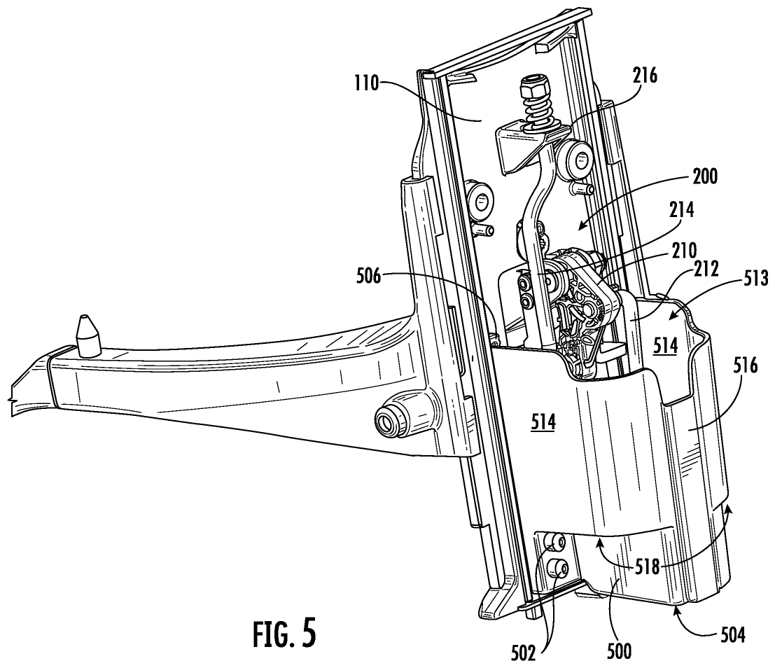

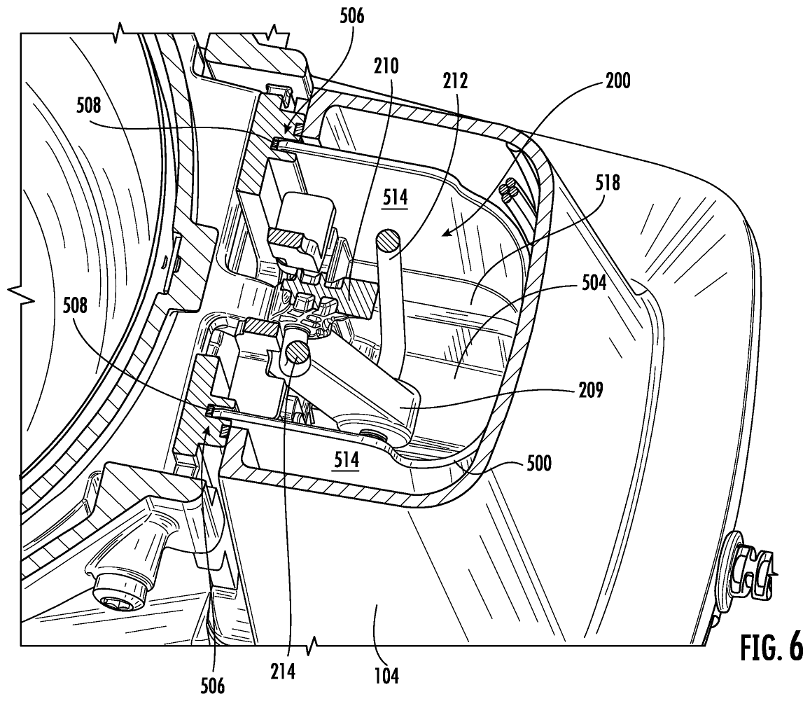

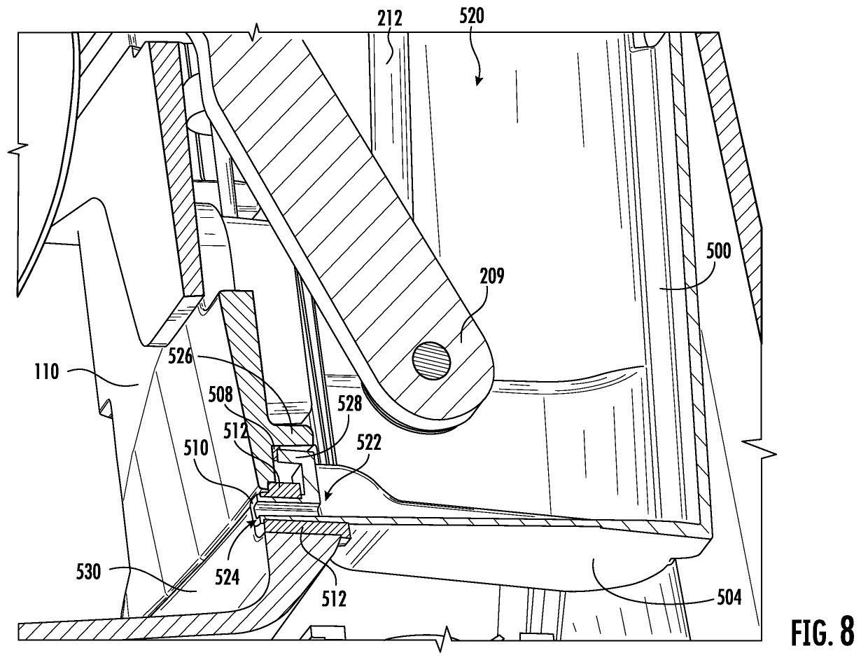

As may be seen throughout FIGS. 5-8, the stand mixer 100 may include a liquid reservoir 500 positioned within the stand mixer 100, such as within the support column 104 and above the base. Liquid reservoir 500 may define an opening 513 between column rail 110, a pair of side walls 514, a rear wall 516, and a bottom wall 504. Side walls 514 may extend in the transverse direction T. Rear wall 516 may extend in the lateral direction L, perpendicular to side walls 514. As seen in FIGS. 5 and 6, the connection between side walls 514 and rear wall 516 may be rounded in order to fit inside the curvature of support column 104. With respect to the vertical direction V, liquid reservoir 500 may be positioned more proximate base 102 than head 106 of stand mixer 100. With respect to the lateral direction L, liquid reservoir 500 may be positioned laterally centered in the support column 104. Bottom wall 504 may be positioned laterally between a pair of shelves 518 extending in the lateral direction from the pair of side walls 514, and vertically below the pair of shelves 518, as seen in FIG. 5. Shelves 518 may be sloped towards bottom wall 504 as to direct liquid from opening 513 to bottom wall 504. In some example embodiments, as seen in FIG. 8, a positioning lip 526 may be disposed on the column rail 110 and may generally be configured for engaging with a front lip 528 of the liquid reservoir 500. Particularly, positioning lip 526 and front lip 528 may sealingly engage with gasket 508 to seal liquid reservoir 500 against column rail 110.

Referring now to FIG. 5 in particular, an example embodiment of a liquid reservoir 500 is shown mounted to column rail 110 according to aspects of the present disclosure. In general, liquid reservoir 500 may be disposed around bar linkage 200 inside of the support column 104. Liquid reservoir 500 may be generally configured to collect and discharge liquid out of support column 104 of stand mixer 100. Liquid reservoir 500 may generally fastened to column rail 110 by a plurality of fasteners 502. In general, two (2) fasteners 502 may be disposed on either side of liquid reservoir 500, such that four (4) fasteners 502 may fasten liquid reservoir 500 to column rail 110. Column rail 110 may include a channel 506 to engage with the liquid reservoir 500 when mounting the liquid reservoir to the column rail 110. Channel 506 will be described in further detail below.

Referring now to FIG. 6, a top perspective view of the liquid reservoir 500 inside of support column 104 is provided. A bottom wall 504 of liquid reservoir 500 may be positioned below bar linkage 200. As stated above, channel 506 may engage with the liquid reservoir 500 when mounting the liquid reservoir to the column rail 110. Particularly, channel 506 may include a gasket 508 to sealingly engage with liquid reservoir 500 inside of channel 506. In general, channel 506 may engage on both sides of liquid reservoir 500, e.g., in the example embodiment there may be two (2) channels 506 and two (2) gaskets 508.

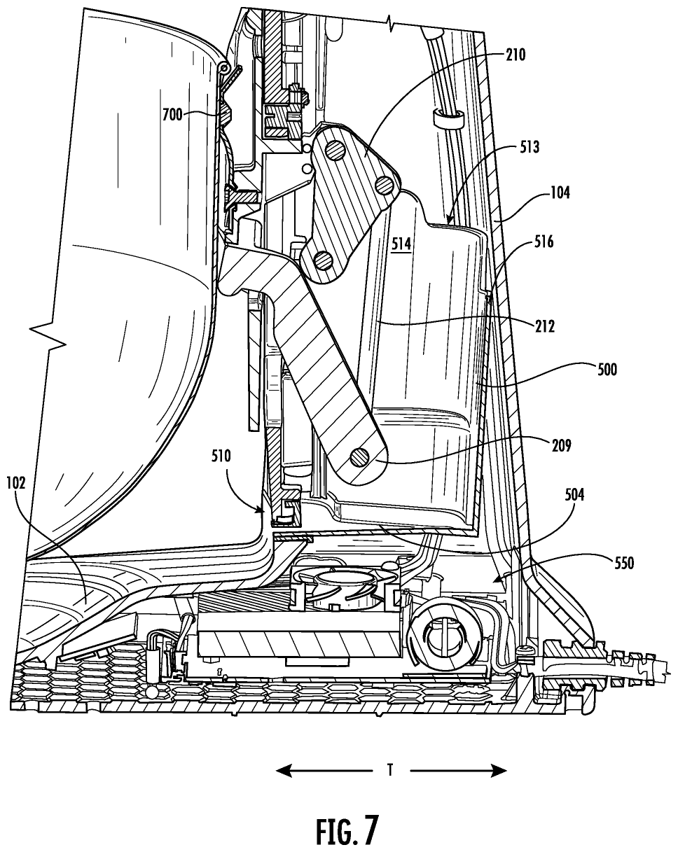

Referring now to FIGS. 7 and 8, as stated above, liquid reservoir 500 may be generally configured to collect and discharge liquid out of support column 104 of stand mixer 100. Particularly, FIG. 7 provides a side view of the liquid reservoir 500 inside of support column 104. Liquid may enter support column 104 through openings between column rail 110 and support column 104, generally shown in FIG. 7 by flow paths 700. Generally, bottom wall 504 may be positioned vertically above an interior 550 of the base 102 of the stand mixer 100, such that liquid may then flow along flow paths 700 and be contained in liquid reservoir 500. The liquid flow may then be discharged from liquid reservoir 500 to outside of support column 104. Particularly, FIG. 8 provides a side perspective view of a spout 510 of liquid reservoir 500. The liquid reservoir 500 may include a spout 510 at the bottom wall 504 of the liquid reservoir 500. In general, the bottom wall 504 of the liquid reservoir 500 may be sloped towards the spout 510 to direct liquid to, towards, and/or through the spout 510. Specifically, spout 510 may generally extend from an inlet 522 at an internal volume 520 of the liquid reservoir 500 to an outlet 524. Gaskets 512 may sealingly engage between support column 110 and spout 510. In some example embodiments, spout 510 may extend to an outer or external face of the stand mixer 100. For example, the spout 510, e.g., the outlet 524 thereof, may be positioned on an external face of the stand mixer 100, such as a front face 530 or a side face 532 of support column 104, as can best be seen in FIG. 1.

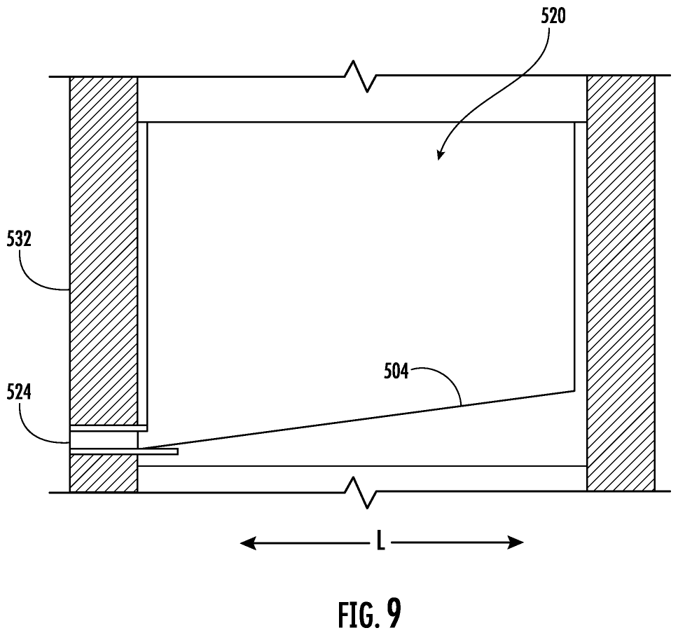

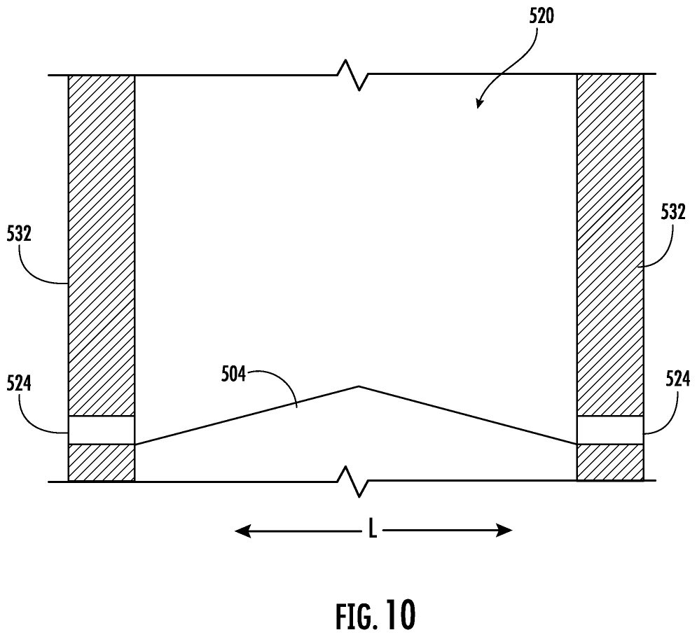

As may be seen in FIGS. 9 and 10, as stated above, spout 510 may extend to an outer or an external face of the stand mixer 100. For example, the spout 510, e.g., the outlet 524 thereof, may be positioned on an external face of the stand mixer 100, such as a front face 530 or a side face 532 of support column 104. FIG. 9 illustrates an example embodiment of outlet 524 positioned at side face 532 of support column 104, with bottom wall 504 of liquid reservoir 500 sloped towards the outlet 524. FIG. 10 illustrates another an example embodiment where bottom wall 504 of the liquid reservoir 500 crowns in the middle and may drain through each side face 532.

As may be seen from the above, stand mixer 100 includes a liquid reservoir 500 inside of the support column 104. The liquid reservoir 500 is configured to protect liquid from entering internal parts in the stand mixer 100 when operating the mixer at high speed, e.g., when making butter or cleaning the stand mixer 100 with water. When liquid leaks into the interior of the base 102, the liquid may cause malfunctions in the system as liquid may damage both the electronics and electrical components in the stand mixer. Thus, the liquid reservoir 500 may advantageously collect the liquid and discharge through a spout 510 through the support column 104 to the outside of the stand mixer.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. A stand mixer defining a vertical direction, a lateral direction, and a transverse direction, wherein the vertical direction, the lateral direction, and the transverse direction are mutually perpendicular, comprising:
a base;
a support column attached to the base and extending upwardly from the base;
a column rail mounted to the support column;
a head attached to an upper end of the support column and extending from the support column above the base;
a bowl lift framework extending outwardly from the support column, the bowl lift framework coupled to the column rail, the bowl lift framework comprising a bar linkage configured for moving vertically relative to the head when the bar linkage pivots relative to the support column; and
a liquid reservoir disposed around the bar linkage inside of the support column, the liquid reservoir comprising a bottom wall positioned above an interior of the base of the stand mixer along the vertical direction, the liquid reservoir configured to prevent liquid from entering the interior of the base.

2. The stand mixer of claim 1, wherein the column rail comprises a channel configured to engage with the liquid reservoir.

3. The stand mixer of claim 2, further comprising a gasket disposed in the channel, the gasket configured to sealingly engage with the liquid reservoir.

4. The stand mixer of claim 1, wherein the liquid reservoir comprises a spout at the bottom wall of the liquid reservoir, the spout extending from an inlet at an internal volume of the liquid reservoir to an outlet.

5. The stand mixer of claim 4, wherein the bottom wall of the liquid reservoir is sloped towards the spout.

6. The stand mixer of claim 4, wherein an outlet of the spout of the liquid reservoir is positioned at an external face of the support column.

7. The stand mixer of claim 4, wherein the liquid reservoir comprises a gasket around the spout, the gasket sealingly engaged with the support column.

8. The stand mixer of claim 1, wherein the liquid reservoir is fastened to the column rail with a plurality of fasteners.

9. A stand mixer, comprising:
a base;
a support column attached to the base and extending upwardly from the base;
a head attached to an upper end of the support column and extending from the support column above the base;
a bowl lift framework extending outwardly from the support column, the bowl lift framework comprising a bar linkage configured for moving relative to the head when the bar linkage pivots relative to the support column; and
a liquid reservoir disposed around the bar linkage inside of the support column.

10. The stand mixer of claim 9, wherein the liquid reservoir comprises a bottom wall positioned vertically above an interior of the base of the stand mixer.

11. The stand mixer of claim 9, further comprising a column rail mounted to the support column.

12. The stand mixer of claim 11, wherein the column rail comprises a channel configured to engage with the liquid reservoir.

13. The stand mixer of claim 12, further comprising a gasket disposed in the channel, the gasket configured to sealingly engage with the liquid reservoir.

14. The stand mixer of claim 10, wherein the liquid reservoir comprises a spout at the bottom wall of the liquid reservoir, the spout extending from an inlet at an internal volume of the liquid reservoir to an outlet.

15. The stand mixer of claim 14, wherein the bottom wall of the liquid reservoir is sloped towards the spout.

16. The stand mixer of claim 14, wherein the outlet of the spout of the liquid reservoir is positioned on an external face of the support column.

17. The stand mixer of claim 14, wherein the liquid reservoir comprises a gasket around the spout, the gasket sealingly engaged with the support column.

18. The stand mixer of claim 12, wherein the liquid reservoir is fastened to the column rail with a plurality of fasteners.
